(19) United States
(12) Patent Application Publication
(10) Pub. No.: US 2006/0100738 A1
(43) Pub. Date: May 11, 2006

(54) Method and apparatus for selecting the operating parameters for a medical imaging system

(75) Inventors: Yasser Alsafadi, Yorktown Heights, NY (US); Larry Eshelman, Ossining, NY (US); Xinxin Zhu, Croton-on-Hudson, NY (US); Amr Yassin, Chesterfield, MO (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/537,872

(22) PCT Filed: Dec. 12, 2003
(86) PCT No.: PCT/IB03/05974

§ 371 Date: Jun. 7, 2005

Related U.S. Application Data
(60) Provisional application No. 60/434,547, filed on Dec. 19, 2002.

(51) Int. Cl. G06F 7/00

(52) U.S. Cl. 700/214

(57) ABSTRACT

A system is provided for guiding the selection of a value for each of a plurality of parameters needed to perform a procedure with a medical system (100). The system includes a first knowledge base (210) comprising procedures and treatment regimes, a second knowledge base (212) comprising patient information and therapy history, and a third knowledge base (214) comprising clinical guidelines. A domain ontology (220) provides the semantic mapping between information in the first, second, and third knowledge bases. A system configuration database (226) contains physical characteristics pertaining to the medical system and a system characteristics database (228) contains mathematical formulas and algorithms for calibrating the medical system based on the data in the system configuration database. An interference engine (224) is also provided for generating a set of parameters based on the information in the first, second, and third knowledge bases, the system configuration database, and the system characteristics database.

The present invention relates generally to medical diagnostic and imaging systems, and more particularly to a method and apparatus for providing improved patient-centered care by guiding the selection of a value for each of the parameters that is most appropriate for an individual patient when performing a procedure with a medical imaging system.

Medical diagnostic and imaging systems are ubiquitous in modem health care facilities. Such systems provide invaluable tools for identifying, diagnosing and treating physical conditions and can greatly reduce the need for surgical diagnostic intervention. In many instances, final diagnosis and treatment proceed only after an attending physician or radiologist has complemented conventional examinations with detailed images of relevant areas and tissues via one or more imaging modalities.

Currently, a number of modalities exist for medical diagnostic and imaging systems. These include computed tomography (CT) systems, x-ray systems (including both conventional and digital or digitized imaging systems), magnetic resonance (MR) systems, positron emission tomography (PET) systems, ultrasound systems, nuclear medicine systems, and so forth. In many instances, these modalities complement one another and offer the physician a range of techniques for imaging particular types of tissue, organs, physiological systems, and so forth.

Medical imaging systems typically include circuitry for acquiring image data and for transforming the data into a useable form, which is then processed to create a reconstructed image of features of interest within the patient. The image data acquisition and processing circuitry is often referred to as a “scanner” regardless of the modality, because some sort of physical or electronic scanning often occurs in the imaging process. The particular components of the system and related circuitry, of course, differ greatly between modalities due to their different physics and data processing requirements.

Imaging a patient with a medical imaging system requires the operator to select appropriate values for various parameters that enhance or optimize image acquisition conditions for the identification, diagnosis or treatment of a given physical condition. As the complexity and sophistication of such systems steadily increases, the number of parameters that must be selected also increases, exceeding 100 or 200 in some cases. For example, some of the parameters that must be selected when performing a procedure with an x-ray CT system include scan type (single slice scan/helical scan (volume scan)), slice thickness, slice interval, volume size, gantry tilt angle, tube voltage, tube current, imaging region size, and scan speed.

It is very inefficient and unrealistic for the operator to manually set each of the imaging system parameters every time imaging is to be performed. For this reason, predefined sets of parameters (“presets”) are often used. Various presets may be provided for different circumstances and different physical conditions. The presets are generally recommended, for example, by the manufacturer or the medical community. The use of preselected set of parameters, however, causes additional problems of their own.

For example, the sets of parameters defining the presets are generally selected so that they are applicable to large, statistically significant populations and are not tailored for an individual patient. Likewise, the preselected set of parameters are generally selected to enhance the diagnosis of a given medical condition based on the detection of features in the images that are typically common to many patients, but which may not account for less common features that may arise in individual patients. That is, the images that can best identify a physical condition in some particular patient may not be the images that are chosen by the presets.

Accordingly, it would be desirable to provide a method and apparatus for performing medical imaging that can be operated in a relatively simple manner such as when a selection of presets are available, but which also provides for a selection of parameter settings that are better tailored to the individual patient. Also, the information on which the selection is based should preferably be easily updated as improved medical knowledge and protocols become available.

In accordance with the present invention, a system is provided for guiding the selection of a value for each of a plurality of parameters needed to perform a procedure with a medical system. The system includes a first knowledge base comprising procedures and treatment regimes, a second knowledge base comprising patient information and therapy history, and a third knowledge base comprising clinical guidelines. A domain ontology provides the semantic mapping between information in the first, second, and third knowledge bases. A system configuration database contains physical characteristics pertaining to the medical system and a system characteristics database contains mathematical formulas and algorithms for calibrating the medical system based on the data in the system configuration database. An interference engine is also provided for generating a set of parameters based on the information in the first, second, and third knowledge bases, the system configuration database, and the system characteristics database.

In accordance with one aspect of the present invention, the medical system is a medical imaging system.

In accordance with another aspect of the present invention, the medical imaging system is selected from the group consisting of computed tomography (CT) systems, x-ray systems, magnetic resonance (MR) systems, positron emission tomography (PET) systems, ultrasound systems, and nuclear medicine systems.

In accordance with another aspect of the present invention, the patient information and therapy history is stored in conformance with a DICOM Standard.

In accordance with another aspect of the present invention, the patient information and therapy history is transmitted in conformance with a HL7 standard.

In accordance with another aspect of the present invention, the procedures and treatment regimes are stored in conformance with a DICOM standard.

In accordance with another aspect of the present invention, the DICOM standard is a DICOM Request Procedures Service Call.

In accordance with another aspect of the present invention, the clinical guidelines are represented in conformance with a standard selected from the group consisting of GLIF, EON, Asbru, Prodigy, Prestige, and ProForma.

In accordance with another aspect of the present invention, the information in the first, second, and third knowledge bases is remotely located at least in part from the medical imaging system.

In accordance with another aspect of the present invention, the medical imaging system communicates with the first, second, and third knowledge bases over a computer network.

In accordance with another aspect of the present invention, the computer network is a local area network.

In accordance with another aspect of the present invention, the computer network is a wide area network.

In accordance with another aspect of the present invention, the wide area network is the Internet.

In accordance with another aspect of the present invention, the domain ontology is a nomenclature in conformance with SNOMED RT/CT.

In accordance with yet another aspect of the invention, a method is provided for guiding the selection of a value for each of a plurality of parameters needed to perform a procedure with a medical imaging system on an individual patient. The method begins by providing information pertaining to procedures and treatment regimes, providing information pertaining to patient information and therapy history for the individual patient, and providing information pertaining to clinical guidelines. A semantic mapping is performed between the information in the first, second, and third knowledge bases. In addition, information pertaining to physical characteristics of the imaging system is provided, as well mathematical formulas and algorithms for calibrating the imaging system based on the information pertaining to physical characteristics of the imaging system. A set of parameters is generated based on the information pertaining to procedures and treatment regimes, the information pertaining to patient information and therapy history for the individual patient, the information pertaining to clinical guidelines, the information pertaining to physical characteristics of the imaging system, and the mathematical formulas and algorithms for calibrating the imaging system.

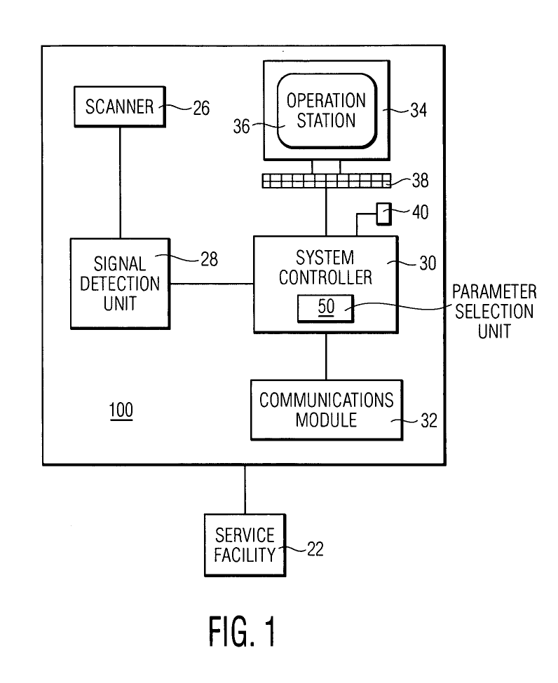

FIG. 1 shows an exemplary block diagram of a medical imaging system in which the present invention may be employed.

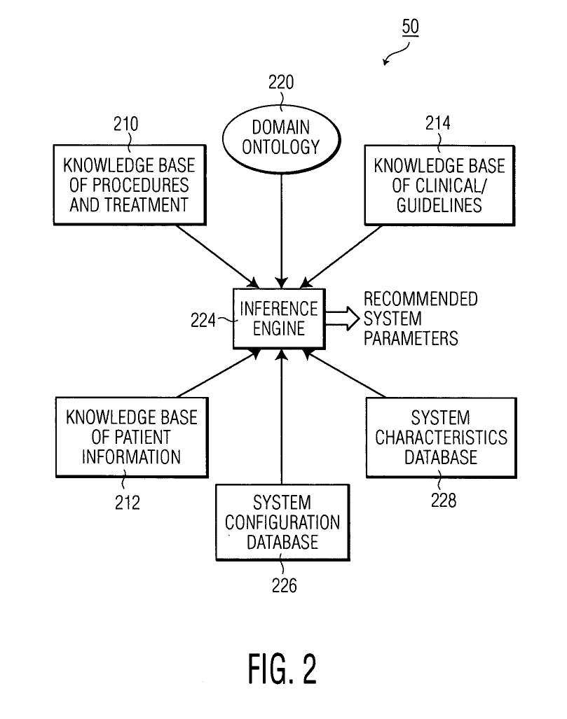

FIG. 2 shows one embodiment of a parameter selection unit constructed in accordance with the present invention.

As will be appreciated by one of ordinary skill in the art, the present invention may be embodied as a method, data processing system, or computer program product. Accordingly, the present invention may take the form of an entirely hardware embodiment, an entirely software embodiment, or an embodiment combining software and hardware aspects. Furthermore, the present invention may take the form of a computer program product on a computer-usable storage medium having computer readable program code means embodied in the medium. Any suitable computer readable medium may be utilized including, but not limited to, hard disks, CD-ROMs, optical storage devices, and magnetic storage devices.

FIG. 1 shows an exemplary block diagram of a medical imaging system 100 in which the present invention may be employed. The medical diagnostic imaging apparatus 100 may be any imaging apparatus available to those of ordinary skill in the art, including but not limited to, an x-ray system, ultrasound system, magnetic resonance imaging (MRI) system, computed axial tomography (CAT) system, and the like.

As shown in FIG. 1, the medical imaging system 100 of this embodiment of the invention includes a scanner 26 coupled to a signal detection circuit 28, which, in turn, is coupled to a system controller 30. System controller 30 includes a uniform platform for interactively exchanging service requests, messages and data with a service facility 22 as described more fully below. System controller 30 is linked to a communications module 32, which may be included in a single or separate physical package from system controller 30. System controller 30 is also linked to an operator station 34 which will typically include a computer monitor 36, a keyboard 38, as well as other input devices 40, such as a mouse. In a typical system, additional components may be included in imaging system 100, such as a printer or photographic system for producing reconstructed images based upon data collected from the scanner 26. Although reference is made herein generally to “scanners” in diagnostic systems, that term should be understood to include medical diagnostic data acquisition equipment generally, not limited to image data acquisition, as well as to picture archiving communications and retrieval systems, image management systems, facility or institution management systems, viewing systems and the like, in the field of medical diagnostics. More particularly, equipment benefiting from the present techniques may include imaging systems, clinical diagnostic systems, physiological monitoring systems and so forth.

By way of example, if the medical imaging system 100 is an MRI system, the scanner 26 generates pulsed magnetic fields and collects signals from emissions by gyromagnetic material within a subject of interest. Similarly, if imaging system is an x-ray CT system, the scanner 26 detects portions of x-ray radiation directed through a subject of interest.

The operator station 34 is used by the technician or operator of the medical imaging system 100 to control the imaging process. In particular, the technician uses the operator station 34 to enter the values of the various parameters that must be selected each time a patient is to undergo an imaging procedure. To simplify this task and to increase the value of the information that is obtained from the procedure, the present invention provides a parameter selection unit 50. As shown in FIG. 1, in some embodiments of the invention the parameter selection unit 50 may be located in the system controller 30.

FIG. 2 shows one embodiment of the inventive parameter selection unit 50 in more detail. The parameter selection unit 50 includes an inference engine 224 and a series of knowledge bases 210, 212, and 214. As described below, the knowledge bases contain facts, rules and methods pertinent to the diagnostic imaging procedure being performed. An inference engine is a general mechanism for inferring new information from the knowledge bases. The inference engine can use rules about the rules (meta-rules) to guide the analysis process. Inference engines are well-known and commercially available and thus do not need to be discussed in further detail.

The knowledge bases employed in the present invention include a knowledge base of procedures and treatment regimes 210, a knowledge base of patient information and therapy history 212, and a knowledge base of clinical guidelines 214. The knowledge bases 210, 212, and 214 may be physically embodied in one or more electronic databases.

The knowledge base of patient information and therapy history 212 includes the pertinent patient-specific information such as the patient's age, weight, gender, and the like. “Patient information” is intended to broadly refer to any clinical information that is or can be stored and processed by a hospital information system, radiology information system, or a cardiology information system. Patient information can include demographic information (e.g., patient name, patient id, etc.) and information regarding a scheduled procedure (e.g., the description, location, date, time, and identifier for a scheduled procedure). The patient information may be stored and transmitted in accordance with an appropriate medical industry standard, e.g., the multi-specialty DICOM Standards (as originally published by an ACR-NEMA committee sponsored by the American College of Radiology and the National Electrical Manufacturers Association as Digital Imaging and Communications in Medicine (DICOM), NEMA Publications PS 3.1-PS3.12., by The National Electrical Manufacturers Association, Rosslyn, Va., 1992, 1993, 1994, 1995). The DICOM Standards define the form and flow of electronic messages that convey images and related information between computers. DICOM attempts to standardize formats for the exchange of image data by defining a standard set of basic and composite data types along with a standard set of requests involving those data types, all of which are representative of the imaging activities in a radiology department.

Another exemplary standard in which the patient information may be transmitted is the Heath Level 7 (“HL7”) standard, which defines formats for electronic data interchange in health-care environments. In particular, HL7 defines message formats for exchange of information relating to a broad range of health-care activities, including patient admissions, discharges, transfers, patient queries, billing, clinical observations, and orders, and eventually patient medical records generally.

The knowledge base of procedures and treatment regimes 210 collects information about the imaging procedure that is being requested for a particular patient This information may be stored and transmitted in accordance with an appropriate medical industry standard such as the aforementioned DICOM Standards, and in particular with the DICOM Request Procedures Service Call.

The knowledge base of clinical guidelines 214 includes protocols and guidelines relating to procedural knowledge. Protocols and guidelines have become an important way to standardize medical care and reduce variance. Clinical guidelines enable professionals from different disciplines to come to an agreement about treatment and devise a quality framework, against which a practice can be measured. Practice guidelines are defined by the Institute of Medicine as “systematically developed statements to assist practitioner and patient decisions about appropriate healthcare for specific clinical circumstances.” Such guidelines are created by panels of physicians based on available clinical data. The development of traditional guidelines is an arduous and expensive process because it often involves detailed review of literature, evaluation of alternatives for all actions, specification of optimal sequences of decisions and actions and documentation of the basis for recommendations. While the distinction between a guideline and protocol is not always clear, they can generally be distinguished based on their degree of flexibility. In particular, a guideline suggests a plan for managing a particular condition while allowing for provider discretion and educated decision-making. Protocols, on the other hand, generally allow much less room for individualized care and clinical decision-making.

Unlike traditional protocols and guidelines, which are typically disseminated as read-only documents, usually in narrative form, the protocols and guidelines employed in the knowledge base of clinical guidelines 214 are prepared in such a way that they can be interpreted algorithmically. A number of multi-step, computer understandable guideline formats (modeled as a hierarchical set of nested guideline tasks) have been developed, including GLIF, EON, Asbru, Prodigy, Prestige, and ProForma. All these formats take a component-based knowledge engineering approach. For example, the EON guideline model developed at Stanford University divides the knowledge base into five components: a temporal model for specifying temporal constraints, a medical concept model, a patient data model, a decision criterion model, and a guideline step model.

The knowledge bases 210, 212, and 214 described above may permanently exist within an electronic memory associated with the operator station 34 depicted in FIG. 1, although they should be updated periodically in accordance with currently available expert knowledge. Accordingly, some embodiments of the invention may be implemented as a system in a client-server environment. Such an embodiment of the inventor is depicted in FIG. 1, in which remotely located service facility 22 is the server and operator station 34 is the client. As is known to those of skill in the art, a client application is the requesting program in a client-server relationship. A server application is a program that awaits and fulfills requests from client programs in the same or other computers. Client-server environments may include public networks, such as the Internet, and private networks often referred to as “intranets”, local area networks (LANs) and wide area networks (WANs), virtual private networks (VPNs), frame relay or direct telephone connections. If a client-server environment is employed, the knowledge bases 210, 212, and 214 may be co-located with the imaging system or, alternatively, they may be located, all or in part, in service facility 22.

Referring again to FIG. 2, the inference engine 224 also receives information from a system configuration database 226 and a system characteristics database 228. The system configuration database 226 contains the physical characteristics and parameters of the system hardware (e.g., the intensity of the x-ray source in an x-ray ray imaging system or the strength of the magnet in an MRI imaging system). The system characteristics database 228 provides the mathematical formulas and algorithms for calibrating the system based on the data in the system configuration database 226.

One problem that arises when the inference engine 224 acquires information from multiple knowledge bases is that the information in each knowledge base may be expressed in different domain ontologies. Accordingly, the parameter selection unit includes a domain ontology 220 that supplies information that is input to the inference engine 224. The domain ontology 220 provides the semantic mapping between the knowledge base of procedures and treatment regimes 210, the knowledge base of patient information and therapy history 212, and the knowledge base of clinical guidelines 214.

An ontology is a document or file that formally defines the relations among terms. That is, the ontology provides the vocabulary in which facts about the domain are phrased. An ontology models knowledge within a particular domain, such as, for example, medicine. An ontology can include a concept network, specialized vocabulary, syntactic forms and inference rules. In particular, an ontology specifies the features (i.e., domain-independent data) that objects (i.e., data or information organized and stored pursuant to a data model) can possess as well as how to extract features from objects. Each feature of an object may have an associated weight, representing the “strength” of the feature or the degree with which the object has the feature. To illustrate the concept of objects and features with a concrete example, consider the medical modality of mammography, which is a method for the early detection of breast cancer. A very large number of features in mammograms have been identified as being important for proper diagnosis, such as clustered microcalcifications, stellate lesions and tumors. Each of these can be represented as a set of medical domain objects with a complex structure. For example, a stellate lesion has a complex structure, consisting of a central mass surrounded by spicules. The spicules, in turn, have a complex, star-shaped structure. Extracting these complex domain objects and their relationships with each other is important for effective detection of breast cancer.

It should be noted that a domain ontology may have subcomponents. Often a domain's concepts include several subdomains, so that its domain ontology is really a merger of several different subdomain ontologies. For example, in the medical domain the domain ontology might consist of a disease ontology, a drug ontology, a patient record ontology, ontologies for various machine modalities, etc. These subontologies describe the basic concepts of different areas of the medical domain and how these concepts are related to each other.

More specifically, in a medical domain one subontology might be an ontology of disorders. The disorders would be arranged in a hierarchy such as the following: (disorder of) organ, heart, heart valve, aortic valve, aortic valve cusp. At each level in the hierarchy there would be associated properties which describe the concept, and which would be inherited by the lower level concepts. Another subontology might be an ontology of diagnostic procedure classes that consist of a hierarchy of various categories of tests. At the top level, the tests might be divided into cardiology tests, laboratory tests, and radiological tests. Each of these tests, in turn, would be divided into more specific tests - e.g., the laboratory tests might include blood chemistry, hematology, microbiology, and urinalysis tests.

One example of a domain ontology that may be employed in the present invention is the SNOMED International work of medical nomenclature. SNOMED International, which is incorporated herein by reference, is a systemized nomenclature of human and veterinary medicine, which is published, copyrighted and maintained by the College of American Pathologists. SNOMED International is an advanced nomenclature and classification of medical terms and codes. In particular, the version of SNOMED referred to as SNOMED RT/CT may be employed as a domain ontology.

1. A system for guiding the selection of a value for each of a plurality of parameters needed to perform a procedure with a medical system 100, comprising:
a first knowledge base 210 comprising procedures and treatment regimes;
a second knowledge base 212 comprising patient information and therapy history;
a third knowledge base 214 comprising clinical guidelines;
a domain ontology 220 provides the semantic mapping between information in the first, second, and third knowledge bases;
a system configuration database 226 containing physical characteristics pertaining to the medical system;
a system characteristics database 228 containing mathematical formulas and algorithms for calibrating the medical system based on the data in the system configuration database; and
an interference engine 224 for generating a set of parameters based on the information in the first, second, and third knowledge bases, the system configuration database, and the system characteristics database.

2. The system of claim 1 wherein said medical system is a medical imaging system.

3. The system of claim 2 wherein said medical imaging system is selected from the group consisting of computed tomography (CT) systems, x-ray systems, magnetic resonance (MR) systems, positron emission tomography (PET) systems, ultrasound systems, and nuclear medicine systems.

4. The system of claim 2 wherein said patient information and therapy history is stored in conformance with a DICOM Standard.

5. The system of claim 2 herein said patient information and therapy history is transmitted in conformance with a HL7 standard.

6. The system of claim 2 wherein said procedures and treatment regimes are stored in conformance with a DICOM standard.

7. The system of claim 6 wherein said DICOM standard is a DICOM Request Procedures Service Call.

8. The system of claim 2 wherein said clinical guidelines are represented in conformance with a standard selected from the group consisting of GLIF, EON, Asbru, Prodigy, Prestige, and ProForma.

9. The system of claim 2 wherein information in said first, second, and third knowledge bases is remotely located at least in part from the medical imaging system.

10. The system of claim 9 wherein the medical imaging system communicates with said first, second, and third knowledge bases over a computer network.

11. The system of claim 10 wherein said computer network is a local area network.

12. The system of claim 10 wherein said computer network is a wide area network.

13. The system of claim 12 wherein said wide area network is the Internet.

14. The system of claim 2 wherein said domain ontology is a nomenclature in conformance with SNOMED RT/CT.

15. A method for guiding the selection of a value for each of a plurality of parameters needed to perform a procedure with a medical imaging system on an individual patient, comprising:
providing information pertaining to procedures and treatment regimes;
providing information pertaining to patient information and therapy history for the individual patient;
providing information pertaining to clinical guidelines;
performing a semantic mapping between the information in the first, second, and third knowledge bases;
providing information pertaining to physical characteristics of the imaging system;
providing mathematical formulas and algorithms for calibrating the imaging system based on the information pertaining to physical characteristics of the imaging system; and
generating a set of parameters based on the information pertaining to procedures and treatment regimes, the information pertaining to patient information and therapy history for the individual patient, the information pertaining to clinical guidelines, the information pertaining to physical characteristics of the imaging system, and the mathematical formulas and algorithms for calibrating the imaging system.

16. The method of claim 15 wherein said imaging system is selected from the group consisting of computed tomography (CT) systems, x-ray systems, magnetic resonance (MR) systems, positron emission tomography (PET) systems, ultrasound systems, and nuclear medicine systems.

17. The method of claim 15 wherein said patient information and therapy history is stored in conformance with a DICOM Standard.

18. The method of claim 15 herein said patient information and therapy history is transmitted in conformance with a HL7 standard.

19. The method of claim 15 wherein said procedures and treatment regimes are stored in conformance with a DICOM standard.

20. The method of claim 19 wherein said DICOM standard is a DICOM Request Procedures Service Call.

21. The method of claim 15 wherein said clinical guidelines are represented in conformance with a standard selected from the group consisting of GLIF, EON, Asbru, Prodigy, Prestige, and ProForma.

22. The method of claim 15 wherein the information pertaining to procedures and treatment regimes, the information pertaining to patient information and therapy history for the individual patient, the information pertaining to clinical guidelines is remotely located at least in part from the medical imaging system.

23. The method of claim 22 wherein the medical imaging system communicates with said first, second, and third knowledge bases over a computer network.

24. The method of claim 23wherein said computer network is a local area network.

25. The method of claim 23 wherein said computer network is a wide area network.

26. The method of claim 25 wherein said wide area network is the Internet.

27. The method of claim 15 wherein the semantic mapping is performed by a domain ontology in conformance with SNOMEDRT.
